(19) United States
(12) Patent Application Publication
(10) Pub. No.: US 2010/0157237 A1
(43) Pub. Date: Jun. 24, 2010

(54) RETAINER FOR SPECTACLES AND METHOD OF USE

(76) Inventors: Sagi MOR, Jerusalem (IL); Tomer BECHAVOD, Jerusalem (IL)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/338,083

(22) Filed: Dec. 18, 2008

(51) Int. Cl. G02C 11/00

(52) U.S. Cl. 351/155; 24/3.3

(57) ABSTRACT

A device for coupling spectacles to an edge of a laminar sheet; the device comprising a front portion coupled to a rear portion at a fold and a retainer for connecting the spectacles to the device, wherein the device further comprises a magnetic fastening system for attaching the device to the laminar sheet.

### FIELD OF THE INVENTION

The present invention relates to devices for holding spectacles, and particularly but not exclusively to fashion accessories for holding spectacles.

### BACKGROUND

Spectacles, particularly reading glasses and sunglasses are worn over the eyes and removed as the wearer takes up and puts down his reading matter or goes in and out of buildings. Spectacle cases are unsightly, bulky and distort pockets, and therefore are rarely carried by wearers. Some occasional spectacle wearers who put on and take off spectacles not infrequently, wear the spectacles on their foreheads when not in use, which is unsightly. Alternatively, the wearer may slide one of the side-arms of the frame of the spectacles into an area of his/her shirt, or other item of clothing, that is open, i.e. a button-hole or a pocket. This action often leads to the loss or breakage of the spectacles since the spectacles will usually slip out of the inserted location.

Another common strategy is to wear the spectacles on a chain around the neck when not in use. This is problematic for care givers of babies since the chain can strangle the baby if it goes around the neck, or it can choke the baby if swallowed. The chain is also a hazard if worn by operators of machinery as it can get caught easily in the machinery and strangle the wearer.

Accordingly, there have been several attempts to design devices created in an effort to fill a need for a device that will allow an individual to hang spectacles, sunglasses, or the like from his/her clothing which is fashionable, and which will avoid the loss or breakage of the spectacles or any of the above mentioned hazards.

Japanese Patent Application Number JP2005024696 describes a clip that is permanently attached to the side-arm of a pair of spectacles for attaching the spectacles to a shirt pocket or hem of a garment when not in use. Although providing a convenient means of securely attaching the spectacles to a shirt pocket or the like, such clips have several disadvantages. For example, they are unaesthetic when the spectacles are in use and may catch on the hair.

Of note, is Chinese patent application number CH0686058 describes a clip for holding an identity card to the wearer's shirt pocket. The clip consists of a flexible strip with a permanent magnet at each end for holding the flexible strip securely onto an item of clothing when folded over to engage the magnets through the clothing. The clip includes a pouch for holding the identity card. It would not be feasible to insert a pair of spectacles, sunglasses, or the like into the pocket shaped pouch of the device, since the pouch is not the correct size or shape to hold a pair of spectacles, sunglasses, or the like. Additionally, such a device is not practical for holding a pair of spectacles, sunglasses, or the like since the pouch simply acts as an unnecessary additional pocket, when the wearer can simply place the spectacles, sunglasses, or the like in the already existing pocket onto which the device is attached. Furthermore, the use of a similar device for spectacles, sunglasses, or the like would not act as a fashion accessory, which adds style to the wears appearance, but would instead act as an eyesore, unattractive and unnecessary, since all that is seen is a bulging pouch extending from the wearer's shirt pocket.

As such, there is a need for an accessory for securing spectacles, sunglasses, or the like onto items of clothing which is both a practical means for holding the spectacles, sunglasses, or the like securely to the wearer's item of clothing, and at the same time fashionable, adding style to the wearer's overall appearance. The present invention addresses this need.

### SUMMARY OF THE INVENTION

In a first aspect, embodiments of the present invention are directed to providing a device for holding spectacles to an edge of a laminar sheet; the device comprising a front portion coupled to a rear portion at a fold and a retainer for connecting the spectacles to the device, wherein the device further comprises a magnetic fastening system for attaching the device to the laminar sheet.

Typically, the spectacles are selected from the group comprising optical spectacles, sunglasses, goggles and eye shields.

Optionally, the front portion and said rear portion form a continuum folded over.

Alternatively, the fold is a hinge.

Additionally, or alternatively, the fold comprises an element that resiliently resists deformation.

Generally, the laminar sheet is a piece of fabric and the edge is a hem.

Typically the laminar sheet is a pocket and the edge is a top part opening to the pocket.

In some embodiments the magnetic fastening system comprises a magnet and keeper. In other embodiments, the magnetic fastening system comprises a pair of mated magnets.

Typically, the retainer is selected from the group comprising a loop, a pouch and a pair of apertures in said front portion.

Optionally, the retainer is transparent for displaying the spectacles.

In some embodiments, the device comprises at least one of the materials selected from the group of precious metals, semiprecious metals, plastics, gemstones, leather and fabrics.

A second aspect is directed to providing a method for coupling spectacles to an edge of a laminar sheet; the method comprising the steps of: (a) supplying a device comprising a front portion coupled to a rear portion at a fold and a retainer for connecting the spectacles to the device, wherein said device further comprises a magnetic fastening system for attaching the device to the laminar sheet; (b) connecting the spectacles to the device, and (c) attaching the device to the laminar sheet.

Alternatively, the method for coupling spectacles to an edge of a laminar sheet comprises the steps of: (i) supplying a device comprising a front portion coupled to a rear portion at a fold and a retainer for connecting the spectacles to the device, wherein the device further comprises a magnetic fastening system for attaching the device to the laminar sheet; (ii) attaching the device to the laminar sheet, and (iii) connecting the spectacles to the device.

Spectacles as used herein refers to a device including a pair of lenses attached to a nose piece or bridge and having side-arms with earpieces at the ends thereof.

### BRIEF DESCRIPTION OF THE FIGURES

For a better understanding of the invention and to show how it may be carried into effect, reference will now be made, purely by way of example, to the accompanying drawings wherein consistent annotation scheme is used throughout, such that the same part is numbered in a similar fashion in all figures where it appears.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1A is an isometric projection of a first embodiment of a device for coupling spectacles to an edge of a laminar sheet such as to a shirt pocket, holding a pair of spectacles and coupled to a patch pocket of a shirt;

FIG. 1B is a side view of the embodiment of FIG. 1A, holding a pair of spectacles and coupled to a patch pocket of a shirt;

FIG. 1C is a side view of the embodiment of FIG. 1A;

FIG. 1D is a front view of the embodiment of FIG. 1A;

FIG. 1E is a back view of the embodiment of FIG. 1A;

FIG. 1F is a top view of the embodiment of FIG. 1A;

FIG. 1G is a bottom view of the embodiment of FIG. 1A;

FIG. 2A is an isometric projection of a second embodiment of a device for coupling spectacles to an edge of a laminar sheet such as to a shirt pocket, holding a pair of spectacles and coupled to a patch pocket of a shirt;

FIG. 2B is a side view of the second embodiment of FIG. 2A, holding a pair of spectacles and coupled to a patch pocket of a shirt;

FIG. 2C is a side view of the second embodiment of FIG. 2A;

FIG. 2D is a front view of the second embodiment of FIG. 2A;

FIG. 2D′ is a front view of the second embodiment of FIG. 2A showing a pouch retainer;

FIG. 2E is a back view of the second embodiment of FIG. 2A;

FIG. 2F is a top view of the second embodiment of FIG. 2A;

FIG. 2G is a bottom view of the second embodiment of FIG. 2A;

FIG. 3A is an isometric projection of a third embodiment of a device for coupling spectacles to an edge of a laminar sheet such as to a shirt pocket, holding a pair of spectacles and coupled to a patch pocket of a shirt;

FIG. 3B is a side view of the third embodiment of FIG. 3A, holding a pair of spectacles and coupled to a patch pocket of a shirt;

FIG. 3C is a side view of the third embodiment of FIG. 3A;

FIG. 3D is a front view of the third embodiment of FIG. 3A;

FIG. 3E is a back view of the third embodiment of FIG. 3A;

FIG. 3F is a top view of the third embodiment of FIG. 3A;

FIG. 3G is a bottom view of the third embodiment of FIG. 3A;

FIG. 4 is a method for coupling spectacles to an edge of a laminar sheet such as a pocket of a shirt.

### DESCRIPTION OF THE PREFERRED EMBODIMENTS

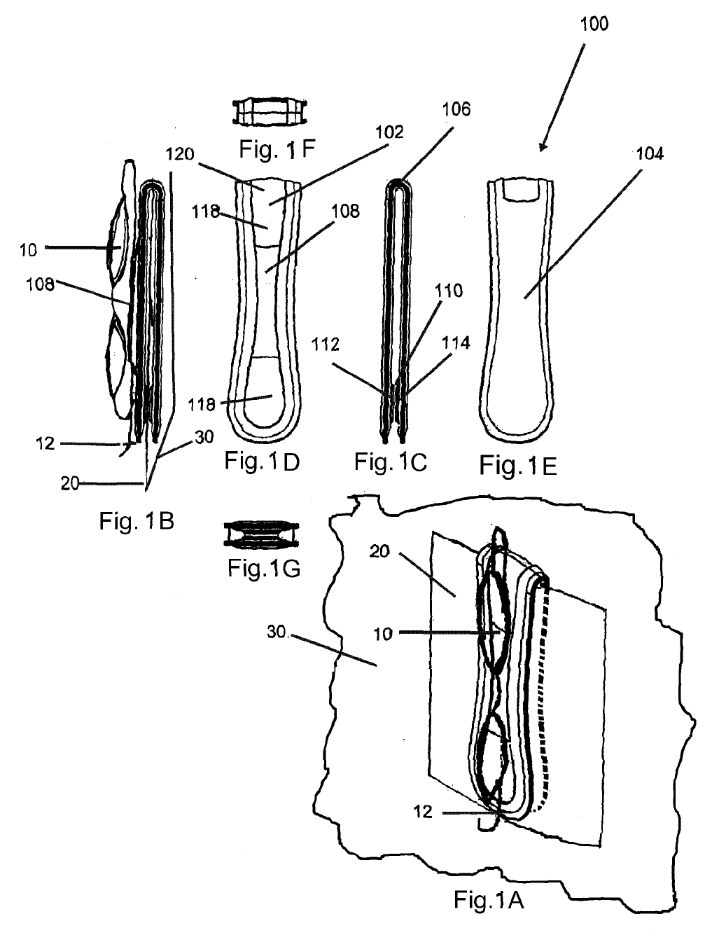

With reference to FIGS. 1A-G, in accordance with one embodiment of the invention, a spectacle coupling device (“device”) 100 for coupling spectacles 10 to an edge of a laminar sheet, such as the breast pocket 20 of a shirt 30, is presented. The device 100 comprises a front portion 102 coupled to a rear portion 104 at a fold 106 and a retainer 108 for coupling the spectacles 10 to the device 100. It is a particular feature of the invention that the device incorporates a magnetic fastening system 110 for attaching the device 10 to the breast pocket.

Although the device 100 is generally used for attaching spectacles to a hem of a breast pocket 20 or other type of patch pocket, the device 100 can effectively attach spectacles 10 or the like to the hem of any garment, or indeed to the edge of any piece of fabric or other thin sheet or laminar material that allows magnetic attraction of the magnetic fastening system 110 there through.

In the embodiment of FIGS. 1A-G, front portion 102 and rear portion 104 are made from a continuous piece of material folded over at fold 106, as best seen in FIG. 1B.

The magnetic fastening system 110 consists of a front element 112 attached to the front portion 102 and a rear element 114 attached to the rear portion 104 of the device 100. In the present embodiment, the front element is a first magnet 112 and the rear element is a second magnet 114. Second magnet 114 is configured with opposing polarity to the first magnet 112 to be attracted therewith through the fabric of the pocket 20, thereby holding the device 100 to the shirt 30.

Retainer 108 is preferably formed from a loop of suitable fabric. To connect the spectacles 10 to the device 100, at least a portion of the spectacles 10, typically a side-arm 12 thereof, is threaded through the channel 118 formed between the retainer 108 and a back-plate 120 of the front portion 102.

Usefully retainer 108 is fabricated from an elastic material that contracts around the side-arm 12 to grip same. In some embodiments, retainer 108 is transparent, for example being fabricated from a piece of polyethylene, or the like.

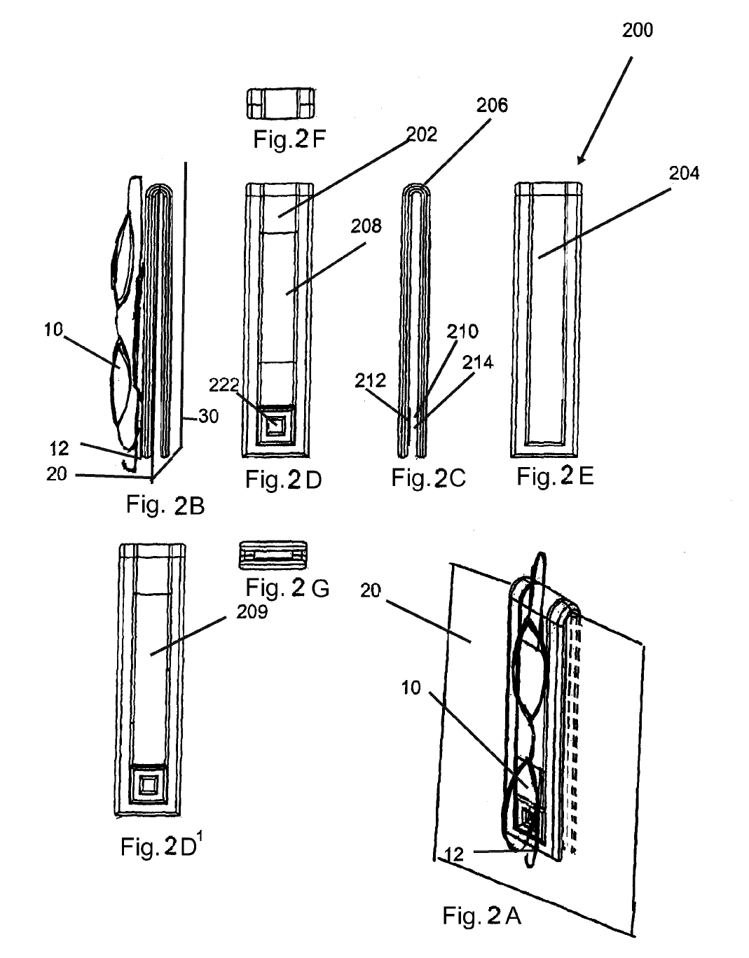

With reference to FIGS. 2A-2G a second embodiment of a spectacle coupling device (“device”) 200 for coupling spectacles 10 to a garment or the like, is presented. The device 200 comprises a front portion 202 coupled to a rear portion 204 at a fold 206 and a retainer 208/209 for connecting the spectacles 10 to the device 200; the device 200 being provided with a magnetic fastening means 210 mutatis mutandis.

The retainer 208 is preferably formed from a loop of suitable fabric, or in the alternative can be a pouch 209 as seen in FIG. 2D′.

The magnetic fastening means 210 may comprise a pair of mutually attracting magnets 112, 114 as in first embodiment. Alternatively, as shown in FIGS. 2A-C and 2G, the magnetic fastening means 210 may consist of a magnet 212 and a keeper 214 consisting of a non-magnetized ferrous stub or the like.

Unlike fold 106 of device 100 of the first embodiment, in embodiment 200, the fold 206 may be formed from a bent piece of metal, or plastic and resiliently resists further deformation. Indeed in some embodiments, fold 206 presses front portion 202 and rear portion 204 together through the material, so the device 200 is attachable to a shirt pocket 20 or similar, even without the magnetic fastening means 210. Nevertheless, provision of the magnetic fastening means 210 adds an additional element of security, preventing the device 200 from becoming detached if the garment is inverted.

Attention is drawn to ornamentation 222. In contradistinction to merely clipping the spectacles 10 to the shirt pocket 20 or carrying a bulky and unattractive spectacles case, device 200 is preferably aesthetically pleasing and may include ornamentation and stylistic elements of various types. For example, the device 200, or at least external parts thereof 202, 208 may be fabricated from precious metals such as silver, gold, platinum and alloys thereof, or from semiprecious metals such as titanium, or could be electroplated or anodized. Embodiments of the device 200 may be studded with gemstones, which may be precious stones such as diamond, sapphire, ruby or emerald, for example, or semiprecious stones such as opals, zirconium, crystals, rhinestones, or paste, that are decorative, but much cheaper. The device 200, or at least parts thereof, may be fabricated from leather or expensive fabrics, or may be fabricated from other, cheaper materials such as steel or plastic.

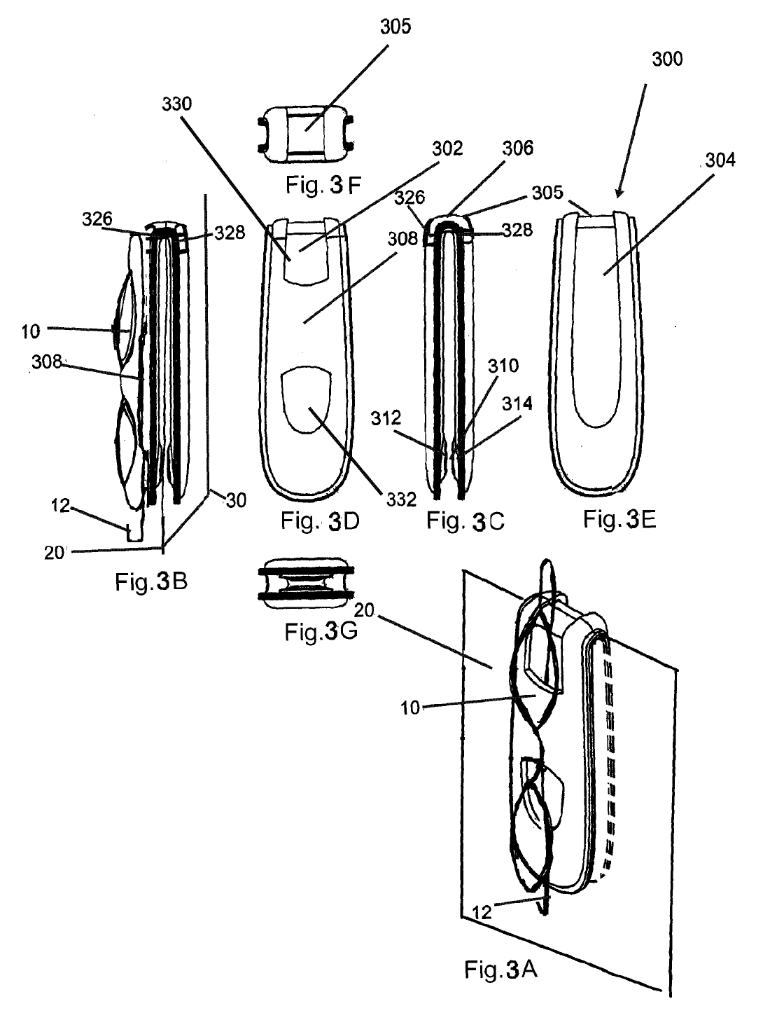

With reference to FIGS. 3A-3G, a third embodiment of the spectacle coupling device (“device”) 300 for holding spectacles 10 to a garment or pocket 20 thereof is shown, mutatis mutandis.

In contradistinction to the previous embodiments, the magnetic fastening means 310 consists of a magnet 314 attached to the rear portion 304 and a keeper 312 attached to the front portion 302. The front portion 302 is attached to a top part 305 by a hinge 326, allowing relatively free rotational movement there between. Similarly, rear portion 304 is attached to the top part 305 by a second hinge 328.

It will be appreciated that the top part 305 is superfluous, and in some embodiments, not shown, the front portion is freely hinged directly to the rear portion at a fold there between, which may be a cloth hinge for example.

In this instance, the retainer 308 consists of the front portion 302 itself, having a pair of apertures 330, 332 therein such that one of the side-arms 12 of the spectacles 10 can be threaded through the apertures 330, 332, in front of or behind the front portion 302 to engage same.

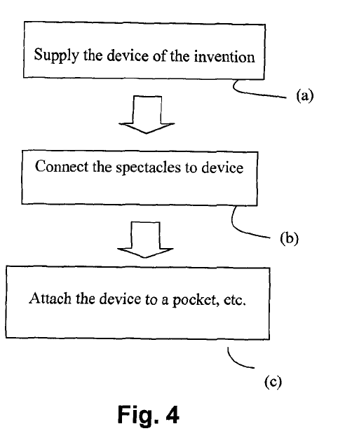

With reference to FIG. 4, a method for coupling spectacles to an edge of a laminar sheet such as a pocket of a shirt or other garment is shown. The method comprising the following steps: supplying the device of the invention—step (a); connecting the spectacles to the device—step (b), and attaching the device to the laminar sheet—step (c). It will be appreciated that steps (b) and (c) could be reversed. In other words, the device could be attached to the pocket and then the spectacles could be attached thereto.

Although described hereinabove with respect to spectacles, that are typically a pair of lenses in a frame that includes a nose piece and side-arms, the lenses being for correcting vision defects, it will be appreciated that the device of the invention as described hereinabove, could be used for non-optical spectacles, such as sunglasses or goggles for protecting the eyes from radiation, eye shields and goggles for protecting the eyes from chemical splashes, shrapnel and the like, motor-cycle goggles for protecting the eyes from wind and dust, swimming goggles for protecting the eyes from water, snow goggles and other forms of eyewear.

The system is capable of some variation, and not all features described are included in all embodiments, furthermore, other features may be included. Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A device for coupling spectacles to an edge of a laminar sheet, the device comprising;
a front portion coupled to a rear portion at a fold,
a retainer for connecting the spectacles to the device, and
a magnetic fastening system for attaching said front and rear portions about the laminar sheet.

2. The device of claim 1, wherein the spectacles are selected from the group which comprises;
optical spectacles,
sunglasses,
goggles, and
eye shields.

3. The device of claim 1, wherein said front portion and said rear portion form a folded continuum folded over.

4. The device of claim 1, wherein said fold is a hinge.

5. The device of claim 1, wherein said fold is provided by an element that resiliently resists deformation.

6. The device of claim 1, wherein said magnetic fastening system comprises;
a magnet, and
keeper.

7. The device of claim 1, wherein said magnetic fastening system comprises a pair of mated magnets.

8. The device of claim 1, wherein said retainer is selected from the group which comprises;
a loop,
a pouch, and
a pair of apertures in said front portion.

9. The device of claim 1, wherein said retainer is transparent.

10. The device of claim 1, wherein the device is made from material selected from the group which comprises;
precious metals,
semiprecious metals,
plastics,
gemstones,
leather, and
fabrics.

11. A method for coupling spectacles to an edge of a laminar sheet;
the method comprising the steps of:
(a) supplying the device of claim 1;
(b) connecting the spectacles to the device, and
(c) attaching the device to the laminar sheet.

12. A method for coupling spectacles to an edge of a laminar sheet;
the method comprising the steps of:
(i) supplying the device of claim 1;
(ii) attaching the device to the laminar sheet, and
(iii) connecting the spectacles to the device.
